(19) United States
(12) Patent Application Publication
(10) Pub. No.: US 2013/0118264 A1
(43) Pub. Date: May 16, 2013

(54) RESISTIVE PRESSURE MEASURING CELL HAVING DIAGNOSTIC CAPABILITIES

(71) Applicants: Heinz Walter, Hergatz (DE); Oliver Blankenhorn, Bodnegg (DE); Jochen Forster, Lindau (DE)

(72) Inventors: Heinz Walter, Hergatz (DE); Oliver Blankenhorn, Bodnegg (DE); Jochen Forster, Lindau (DE)

(73) Assignee: IFM ELECTRONIC GMBH, ESSEN (DE)

(21) Appl. No.: 13/812,157

(22) PCT Filed: Aug. 30, 2011
(86) PCT No.: PCT/EP11/64892

§ 371 Date: Jan. 25, 2013

(30) Foreign Application Priority Data
Aug. 30, 2010 (DE) 10 2010 035 862.2
Oct. 15, 2010 (DE) 10 2010 042 536.2

(51) Int. Cl. G01L 9/00

(52) U.S. Cl. CPC G01L 9/00
USPC 73/717

(57) ABSTRACT

A pressure measuring cell for detecting the pressure prevailing in an adjoining medium, comprising an elastic membrane on which a first electromechanical transducer is arranged, which supplies a first pressure-dependent output signal is provided. According to the invention, a second electromechanical transducer, which supplies a second pressure-dependent output signal, is arranged on the membrane wherein the two transducers are arranged such that with an elastically reversible deformation of the membrane the output signals have a first pressure characteristic, and after an irreversible deformation of the membrane due to an increased pressure load same have a significantly different second pressure characteristic.

### FIELD OF TECHNOLOGY

The invention relates to a pressure measuring cell for detecting the pressure prevailing in an adjoining medium, comprising an evaluation circuit for such a pressure measuring cell and an electronic pressure measuring device consisting of a process connection, a housing placed thereon and one such measuring cell. The invention further relates to a method for diagnostic pressure detection.

### BACKGROUND

Measuring cells and measuring devices of the type at issue have been known for quite some time and are used, for example, in many process measuring technology areas for metrological process monitoring. The measuring cell is a component of the measuring device, said measuring cell having the elementary task of detecting the physical variable of pressure directly or indirectly, and converting it into a corresponding measuring signal. Such measuring devices are manufactured and put on the market by the applicant under the device designation PTxx and PKxx. Currently, the measuring ranges usually extend up to 400 bar.

During pressure measurements, the pressure in a medium adjoining the measuring cell should be detected frequently, the measuring cell having an elastic membrane whose one side is at least partially in contact with the medium and whose other side is facing away from the medium. The pressure in the usually gaseous, fluid, pasty or at least free flowing medium is calculated such that the elastic medium deflects the elastic membrane at different intensities depending on the pressure prevailing in the medium. The deflection or reversible deformation of the membrane is converted into a corresponding measuring signal, for example by a strain gauge which is deformed with the deflected membrane, into a corresponding resistance value, or voltage or current value.

The durability of a measuring cell or of a measuring device cannot be determined, or only inaccurately determined because of the possibly very significantly varying load. A single, short-term pressure impulse on the membrane of a pressure measuring cell, for example, can cause the immediate destruction of the measuring device or of the pressure measuring cell, if the membrane is damaged. It can be irreversibly, i.e. plastically deformed or torn. Steel, silicon or ceramic are essentially used as a material for the surface of the membrane. Silicon and ceramic are relatively brittle so that no plastic deformation occurs. A plastic deformation can occur, however, in measuring cells made of steel, for example, due to overload. This deformation can cause a signal interpreted as a pressure value, to be measured, which merely occurs because of the undesired plastic deformation and does not correspond to the actual pressure. As a result, the measuring cell does not provide a reliable measuring signal from which it can be deduced whether pressure is present and if so at what level.

The problem is now to determine whether a measured value has been calculated because of damage to the measuring cell that is therefore erroneous, or whether the measured value corresponds to the actual pressure value in the medium within the measurement precision. The reliability of the measuring signals is in particular an essential aspect as to their validity in installations requiring compliance with the corresponding stages of the Safety Instrumented Function (SIL).

One possibility is to create corresponding redundancy systems. Such a possibility provides the use of two measuring devices, both being different regarding their pressure range, and the measuring device with the higher pressure resistance—but also lower measuring precision—taking over the redundancy function. In this way it is possible to determine whether both measuring devices approximately measure the same pressure because, in case of excessive pressure, the more robust measuring device with the higher pressure resistance will still measure the actual pressure, while the other measuring device will show a diverging value owing to the damage to the measuring cell. If a difference is determined, corresponding measures can then be taken. The disadvantage is that this solution is expensive and complex because of the double configuration, even if the redundant systems are integrated in a common housing. On the other hand, systematic errors cannot be detected, or only detected with difficulty in this way.

DE 10 2007 016 792 A1 proposes to activate the membrane and thus the measuring cell by means of a deflection medium capable of being activated, wherein the deflection medium capable of being activated preferably reacts to the excitation by detecting those physical variables the measuring cell is anyway intended to detect. The reaction of the measuring cell to the excitation caused by the deflection medium capable of being activated, among other things, depends on whether the measuring cell is damaged or not, so that the operating state of the measuring cell or of the measuring device can actively be diagnosed. Changes on the elastic membrane have a significant impact on the reaction of the measuring cell, so that an error can be recognized by comparing the actual system response to the expected system response of an intact measuring cell. The condition, however, is that the deflection medium is an element capable of being activated by an electric voltage, a piezo element, for example.

DE 195 27 687 A1, which is considered as the nearest prior art, proposes a pressure sensor having a measuring membrane with two resistance bridges, whereby an unbalance of both bridges results from the deflection of the measuring membrane allowing for the assessment of the resultant change in the diagonal voltage of the bridge. Both resistance bridges are each arranged on one half of the measuring membrane, two opposite bridge branches being modified by the radial compression in each of the resistance bridges, and the resistance of the other bridge branches being modified in their resistance values by radial or tangential elongation. The disadvantage of this embodiment is, on the one hand, that the measuring bridges are arranged spaced apart from the mid-line of the measuring membrane. Consequently, an almost inevitable warping of the membrane can cause a screw drift—because of tolerances of the sealing surfaces and threaded ends—when the pressure measuring device is screwed into the counter piece of the process adapter up to the sealing torque. This acts as a measurement shift of, e.g., up to one percent of the final value of the measurement range, depending, among other things, on the properties of the counter piece of the process adapter, and can therefore not be adjusted in the unmounted state. However, it can be avoided or at least considerably reduced by arranging the bridges in a central position.

On the other hand, in DE 195 27 687 A1, in order to obtain almost similar measuring ranges on evaluating the diagonal voltage of the bridges, the bridge resistances R2 and R3 of the left half of the sensor have to be placed in an area of the measuring membrane in which an elongation will be detected which is similar to that at the bridge resistances R2 and R3 of the left half of the sensor. This requirement results in that the bridge resistances cannot be arranged in the center of the measuring membrane where they are subjected to the maximum elongation, i.e., where the maximum signaling range is found. The consequence is a signal loss and thus a poor signal evaluation.

### SUMMARY

The underlying object of the present invention is to further improve a pressure measuring cell and a pressure measuring device with self-diagnostic capabilities, in particular for the detection of plastic deformations of the membrane.

According to the present invention, the indicated object is attained by means of a pressure measuring cell having the characteristics of claim 1, an evaluation circuit for such a pressure measuring cell having the characteristics of claim 8, an electronic pressure measuring device having the characteristics of claim 10 as well as by means of a method having the characteristics of claim 12. Advantageous embodiments of the invention are specified in the dependent claims.

According to the present invention, both transducers are arranged such that their output signals have a first pressure characteristic in case of an reversible elastic deformation of the membrane and a significantly different second pressure characteristic after an irreversible deformation of the membrane by an increased pressure load. This means that, in case of an irreversible, i.e. plastic deformation, contrary to the elastic deformation in normal cases, the output signals of the electromechanical transducers behave differently relative to one another such that this difference can be detected and the deformation can thus be indicated as an error. The formulation “increased pressure load” should be understood as any impact that will deform the membrane as a result of the pressure applied thereon, in particular, caused by the pressure in the medium itself, but also by particles, like stones or other particles which are present, deliberately or not, in the medium.

Furthermore, according to the present invention, the measuring elements of at least one transducer are arranged on a first mid-line of the membrane. In this way, the utilization of the entire membrane is achieved and a screw drift prevented.

It is particularly advantageous to arrange the measuring elements of both transducers on a first mid-line or on a second mid-line which is perpendicular to the first mid-line. What is important in any case is that the measuring elements are located on the mid-line or on the axis of symmetry. Only in such a way is it possible to prevent that a screw drift occurs when the pressure measuring device is screwed into a counter piece of the process adapter.

The membrane of the pressure measuring device according to the present invention is preferentially realized as a steel membrane on which several measuring elements are interconnected in the inner area to form an electromechanical transducer, in particular a resistance bridge. It is, however, also conceivable that the transducers are configured as voltage dividers, or alternatively as a combination, i.e. by configuring the first transducer as a measuring bridge and the second transducer as a voltage divider. A resistance bridge is, however, advantageous because the signal swing, i.e. the resistance change, is doubled, as a result of which a higher resolution is achieved, the detection of small signal changes being therefore easier. Depending on the requirement, the configuration of the voltage dividers can also be advantageous, in particular, if it is important to realize a possibly cost-effective configuration and the lower signal changes are less important because, for example, the minimum signal changes are sufficiently large to ensure a detection at any time.

Both transducers are independent of one another, i.e. they do not interact and are electronically decoupled from one another. Consequently, a redundancy system is thus proposed, i.e. two independent measuring systems which are however located on the same surface of the membrane of a pressure measuring cell. Strain gauges or a resistance paste are in particular possible as measuring elements. The strain gauges can be configured as a thick film resistance using the thick film technique, or, alternatively, as a thin film resistance using the thin film technique. Depending on the application, the measuring elements to be used are selected on the basis of the different properties of these alternatives, for example regarding the overload and burst strength resistance, nominal pressure range, accuracy, size, weight as well as signal swing and not least with regard to the costs to be expected.

The surface of the side of the membrane facing away from the medium is advantageously divided into at least three concentric areas in which the membrane has a different deflection behavior when pressure is applied, and each area has at least one measuring element. The use of four concentric areas is advantageous. In this case, both transducers are formed by measuring elements consisting of two areas of the membrane surface each. Thus, the following possibilities result: the measuring elements of the first transducer are located in the innermost and second innermost area, so that the measuring elements of the second transducer are located in the outermost and second outermost area; the measuring elements of the first transducer are located in the innermost and second outermost area, so that the measuring elements of the second transducer are located in the outermost and second innermost area; the measuring elements of the first transducer are located in the innermost and outermost area, so that the measuring elements of the second transducer are located in the second outermost and second innermost area. In this way, both transducers are located in different areas of the membrane in which the membrane has a different deflection behavior when pressure is applied. Apart from the redundancy, diversity is thus also achieved.

It is, however, also basically possible to divide the membrane into only three concentric areas. In this case, both central areas, that is the second outermost and the second innermost area of the four-area variant, are unified, so that the respective resistances are arranged, for example, placed next to one another in the same area. This takes advantage of the fact that a plastic deformation expands from the inside to the outside, and the resistances in the innermost area thus always have a lead over the resistances in the outer areas. Unless otherwise specified, only the configuration with four areas will be described and explained below. Then of course, under the proviso that both central areas are unified, the descriptions can also be applied to embodiments with three areas.

Owing to the different position of the measuring elements, both transducers have a different, but known, signal sequence in the nominal pressure range. By means of correspondingly adjusted amplification factors both signal sequences can be corrected such that they are almost congruent. Smaller deviations from the congruence fall within the tolerance. The difference between both signals is thus essentially null. It is also conceivable to determine the ratio of both signals, which is then basically equal to one.

The essential concept of the invention now consists in arranging the measuring elements of both measuring bridges in positions on the membrane which, in case of an undesired plastic deformation, deform at different intensities so that the resultant signal sequences of both transducers can no longer be made to coincide with the previous (stable) correction factor. This correction or signal adjustment can be made, for example, by using different amplification factors for both signals, or also in a processor unit, e.g. in a micro-controller, in a virtual manner. The difference of both signals is thus not equal to zero or the ratio not equal to one. It is ultimately not about verifying the value of the actual measuring result but about verifying whether the difference or the ratio of both signals is null or one. If there are deviations in this case, a plastic deformation of the surface of the membrane can be assumed without having to recognize the measured value as erroneous, as in classical redundancy systems. As a result, the basic concept is to take advantage of the fact that in case of a plastic deformation the deformation characteristic of the membrane is different from that in case of an elastic deformation, which ultimately manifests itself in the modification of the signal difference or of the signal ratio.

In a preferred embodiment of the pressure measuring cell according to the present invention, the measuring element of the innermost area and the measuring element of the outermost area are each a component of different transducers. In this connection it is irrelevant to what transducer the measuring elements of the second innermost and of the second outermost area correspond. In this embodiment, the measuring elements of the first transducer are located in the area of the largest deformation, so that this transducer can generate a clear useful signal. It is then also sufficient for the second transducer, which as such only has a reference function, to arrange its measuring elements in positions where a less clear signal can be generated. The membrane is in turn more robust at these positions, i.e. it is not so vulnerable to pressure peaks.

In another preferred embodiment of the pressure measuring cell according to the present invention, all measuring elements are at least identical regarding the material, i.e. all measuring elements are either configured as a strain gauge or a resistance paste or a piezo element and ideally still of the same size. As a result of this, the influence of thermal effects is lower because they act similarly on each measuring element.

In an especially preferred embodiment of the pressure measuring cell according to the present invention, the membrane has a reduced thickness in at least one of the inner areas, preferentially in the innermost and second innermost area. Owing to the thinner membrane, a stronger deformation occurs in this position which results in a clearer useful signal. On the other hand, a predetermined bending point can be realized for the deformation in this way, which facilitates the positioning of the measuring elements.

In a second aspect, the invention relates to an evaluation circuit for a pressure measuring cell mentioned above, with a first sensing element formed of first measuring elements, with an amplifying unit connected downstream of the first sensing element, with a comparison unit connected downstream of the amplifying unit, and with a controller connected downstream of the comparison unit; with a sensing element formed by second measuring elements, with a second amplifying unit connected downstream of the second sensing element which is connected downstream of the comparison unit, both sensing elements being differently influenced by the pressure applied to the measuring device.

In an advantageous further development, the first and second measuring elements are arranged on a common membrane of the pressure measuring cell. As already explained, the term “sensing element” should be understood as the actual sensors, i.e. a resistance bridge or a voltage divider. On the one hand, the function of the comparison unit consists in determining—depending on the application—a difference or a ratio of both signals received from the amplifying units, and subsequently comparing this difference or ratio to a defined area formed by an upper and a lower threshold value. This can be realized in different ways. For this purpose, comparators, in particular window comparators are preferably used. However, it is also conceivable to send the measuring signals of the sensing elements to an A/D transducer in order to have the comparison function carried out by a microprocessor. The comparison function could also be carried out by the control unit connected downstream, for example an SPS. In such case, the amplified measuring signals would be directly transmitted to the control unit. The term “comparison unit” in connection with the evaluation circuit in this case also applies to the part of a control unit.

In a third aspect, the invention relates to an electronic pressure measuring device consisting of a process connection, a housing placed thereon and of a measuring cell to detect the pressure prevailing in the medium. According to the present invention, the measuring cell is configured in the manner described above. In an advantageous further development, the electronic pressure measuring device comprises an evaluation circuit of the configuration mentioned above.

In a fourth aspect, the invention relates to a method for the diagnostic pressure measurement characterized by the following process steps:

simultaneous pressure measurement in a first sensing element and in a second sensing element in the form of measuring signals essentially depending on the pressure, both sensing elements being components of the pressure measuring cell described above;
amplification of the measuring signals in internal amplifying units dedicated to the respective amplifying units, both characteristics being essentially made to coincide by using respectively different amplifying factors.
determination of the difference or of the ratio of both signals, comparison of the difference or ratio to the predetermined upper and/or lower threshold value; output of an error signal if the difference or ratio exceeds or falls short of the predetermined threshold values.

According to the present invention, the sensing elements, which, as described above, are located on the same surface of the membrane of the pressure measuring cell, simultaneously detect the actual pressure. The measuring signal generated by the sensing elements is therefore “essentially” depending on the pressure because also other influences, like temperature and material properties can be involved. However, their influence is significantly less than that of the pressure. The generated measuring signals are preferentially voltage signals because voltage signals depending on the resistance changes can be generated from a resistance bridge in a simple and known manner. However, current signals are also conceivable.

Owing to the different position of both sensing elements and the different measuring accuracy associated therewith, their signal sequences are different. As a rule, there is an essentially linear proportionality between the acting pressure and the resistance changes generated therewith or the pressure resulting thereof, i.e. the signal sequences appear as an almost straight line, the different measuring accuracy being displayed as different increases. As already mentioned, the deviations from pure linearity result, for example, from the influence of temperature which can have different effects because of the different material properties. The method now provides that these two measuring signals are essentially made to coincide by adjusted amplifying factors. This occurs during the first adjustment of the measuring device and normally does not require any further change. By electronically adjusting the signal sequences, the sensing elements can be arranged on the membrane in an area of maximum signal generation, as a result of which an optimal signal evaluation is possible.

Subsequently, either the difference or the ratio is determined by both—corrected and made to coincide—measuring signals. The difference should now essentially be null and the ratio essentially one. During the subsequent comparisons with an upper and/or lower threshold value, a value of null or one will be recognized as a reliable value. But if a plastic deformation of the membrane has occurred, an offset value is added to the actual measuring value, whose amount depends on the degree of plastic deformation. As the deformation characteristic of the membrane are different in case of a plastic deformation than in case of an elastic deformation, the offset values are different in each of both sensing elements, which results in that the difference now deviates from null or the ratio from one such that this value is outside the admissible range or window. If this is the case, an error signal is output as the next process step. If the comparison is made in a control unit, this error signal can either be a directly output warning signal, or, according to an advantageous further development be first [sent] to a controller, for example a current regulator, which then generates an output signal which lies outside a defined range. With a current regulator which outputs a signal of 4.20 mA at the output during normal operation, the error signal could then be output, for example, as a current of ≦3.5 mA or ≧20.5 mA. In a preferred further development of the controller, this signal could then be sent to a control unit connected downstream, which can then start predetermined safety measures, e.g. output of optical and/or acoustical warning signals or switch the installation to be controlled by the control unit to an unpowered state. Further measures are conceivable, so that the invention is not solely limited to those mentioned in this document.

### BRIEF DESCRIPTION

The invention will be explained in more detail below in connection with the figures and with reference to exemplary embodiments.

The figures show:

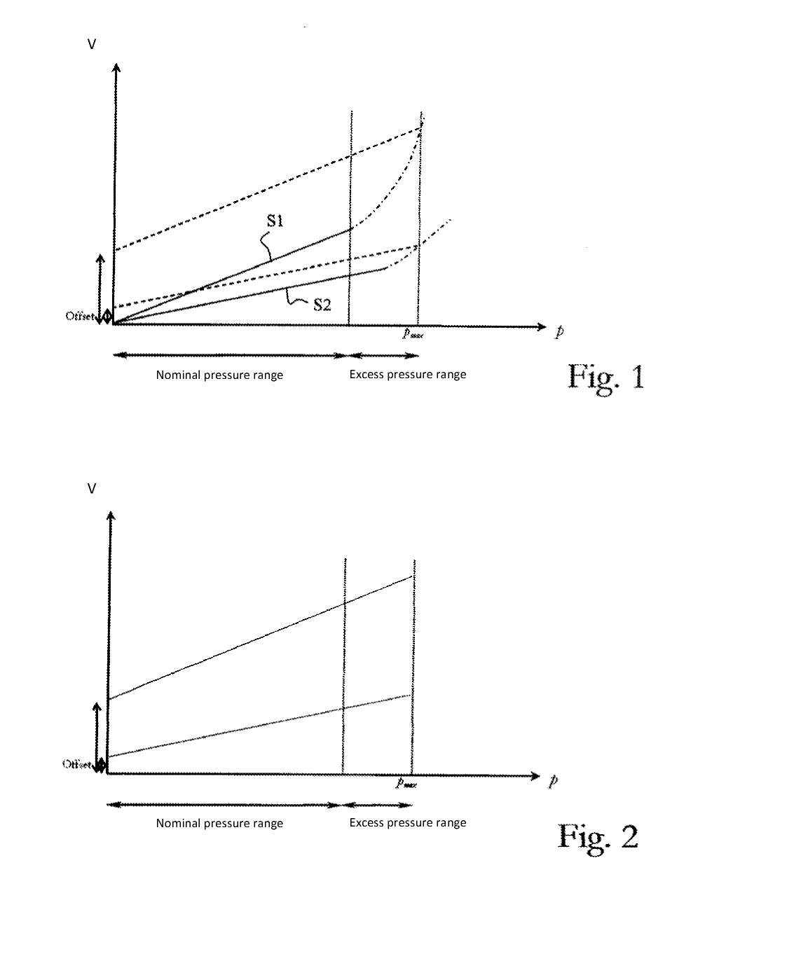

FIG. 1, a diagram of the uncorrected signal sequences of the measuring bridges before and after a plastic deformation.

FIG. 2, a diagram of the uncorrected signal sequences of the measuring bridges on return to the nominal pressure range after a plastic deformation,

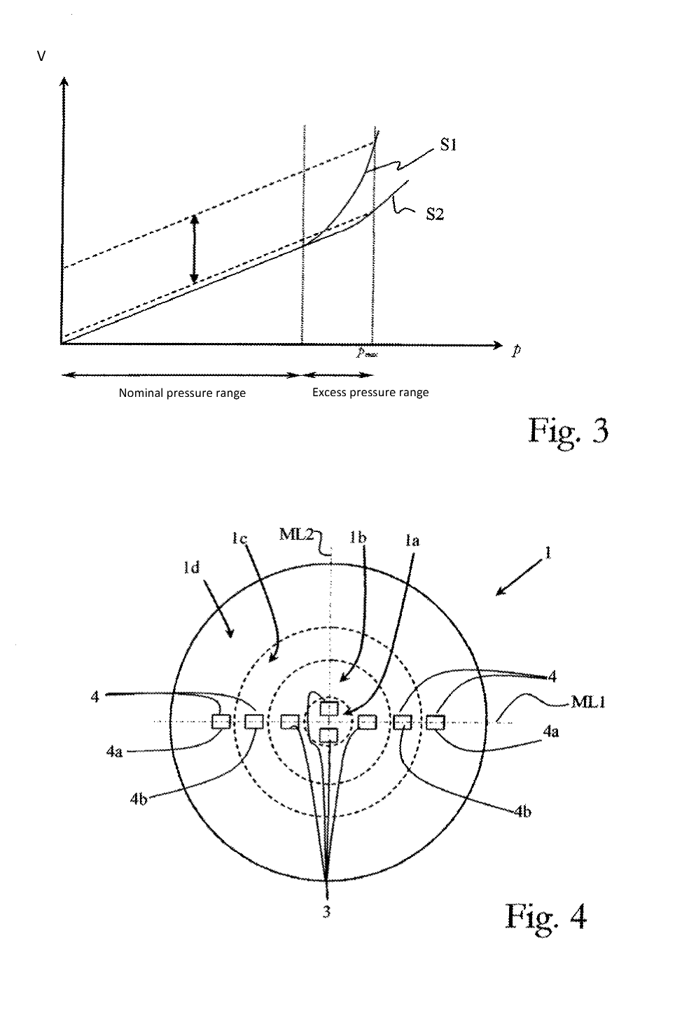

FIG. 3, a diagram of the corrected, i.e. made to coincide, signal sequences before and after a plastic deformation,

FIG. 4, a top view of an exemplary embodiment of a pressure measuring cell according to the present invention,

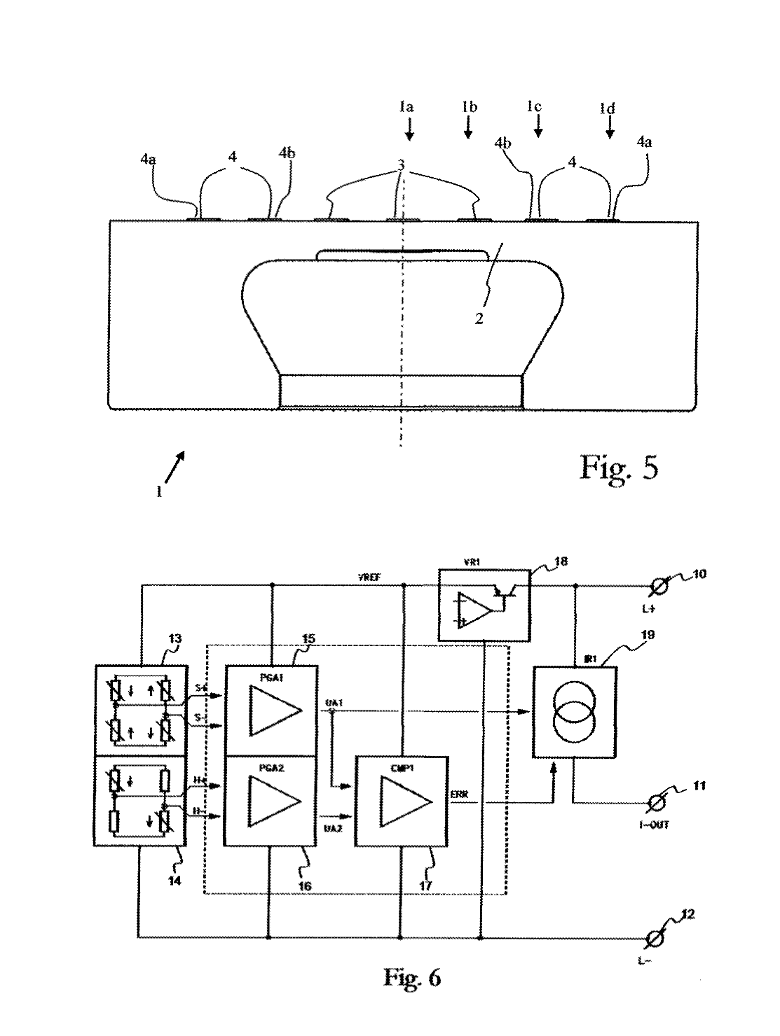

FIG. 5, a lateral sectional view of an exemplary embodiment of the pressure measuring cell according to the present invention and

FIG. 6, a block diagram of the pressure measuring device according to the present invention as a 3-wire circuit.

### DETAILED DESCRIPTION

Unless otherwise specified, like reference numerals designate like components of the same relevance.

FIG. 1 illustrates a diagram that shows the signal sequences S1, S2 of the measuring bridges 13, 14, i.e. the change in voltage resulting from the change in resistance depending on the actual pressure, before and after a plastic deformation of the membrane 2, namely without correction or modification of the signals S1, S2, for example, by means of different amplification factors. It should be pointed out in the first instance that the diagrams of the FIGS. 1 to 3 below should merely be understood as schematic illustrations in order to clarify the problem. The selected signal sequences S1, S2 are purely deliberate and can therefore deviate from real values. It should further be noted that the FIGS. 1 to 3 are based on the preferred embodiment, in which the first measuring bridge 13 is located in both inner areas 1a, 1b of the membrane 2, and the second measuring bridge 14 is located in both outer areas 1c, 1d.

It can be assumed that the change in voltage increases almost linearly with the pressure in the nominal pressure range. The straight line S1 with the greater increase is generated by the first measuring bridge 13 which is located in the inner areas 1a, 1b. The change in voltage via the pressure is greatest here. The flat straight line S2 is generated by the second measuring bridge 14 which is located in the outer areas 1c, 1d. The change in voltage via the pressure is lesser here than in the center of the measuring cell 1. The measuring cell 1 is in turn more robust in the outer areas 1c, 1d, i.e. the signal sequence is still linear beyond the nominal pressure range.

The dash-dotted lines in continuation of both straight lines should represent the signal sequence, how it behaves when the pressure increases beyond the nominal pressure range and the measuring cell 1 thus reaches the range of plastic deformation. The measuring cell 1 deforms elastically within the nominal pressure range, so that no irreversible deformations of the membrane 2 occur within this pressure range.

The value pₘₐₓ characterizes the value which the measuring cell 1 is maximally subjected to, for example, the maximum value of a pressure peak. If the pressure again decreases, the signal sequence moves along the dash-dotted lines. It becomes clear that, contrary to the original situation, an offset voltage also results for each value. The cause is that the membrane 2 is subjected to an additional deflection owing to the plastic deformation. The first measuring bridge 13 then displays a voltage value that is falsely interpreted by an evaluation unit as an increased pressure value.

FIG. 2 again shows how the signal sequences of both measuring bridges 13, 14 behave after a plastic deformation of the membrane 2 on returning to the nominal pressure range, which is shown in FIG. 1 as a dashed line. This should again clarify the problem that a voltage signal is still generated by both measuring bridges 13, 14, but in particular by the first measuring bridge 13 even if p=0. The evaluation unit connected downstream would, however, interpret this voltage value as p>0. The greater the degree of deformation of the membrane 2, the greater the appearing offset voltage. As already explained, the signal sequences are also only schematically shown in this figure; real values may deviate therefrom.

In order to counter this problem according to the present invention the signal sequences of both measuring bridges 13, 14 are in the first instance made to coincide by amplifying the signals S1, S2 of both measuring bridges 13, 14 in the amplifying units 15, 16 connected downstream from them by means of different factors. The result is shown schematically in FIG. 3. The progression of both curves 51, S2 is in the first instance superimposed from the point of origin up to the boundary of the nominal pressure range. In the overpressure range, the measuring bridge 13 is the first to drift in the inner area of the membrane, i.e. it leaves the linear course. The signals S2 of the measuring bridge 14 located in the outer areas 1c, 1d of the membrane 2 only leave the linear course later. The reason for this is that the outer areas 1c, 1d of the membrane 2 clearly are more robust, and therefore the transition from the elastic to plastic deformation is only reached at higher pressures.

The value pₘₐₓ identifies the maximum value of an overpressure peak. If the actual pressure is again in the nominal pressure range after an overpressure peak, the signal sequences 51, S2 approximately move according to the dashed line, as is known from FIGS. 1 and 2. They need not necessarily run parallel, as shown in FIG. 3, but can also have a non-parallel course. What is important is the fact that a difference has occurred between both dashed lines, identified by the vertical arrow, whereas a difference of null or almost null results with regular signals—continuous line—in the nominal pressure range because of the congruence between both signals S1, S2. It is clear from FIG. 3 that a difference between both curves, i.e. between the amplified and thus corrected voltage values of both measuring bridges 13, 14 will only result if the actual pressure at the membrane 2 has left the nominal pressure range and the membrane 2 has thereby been subjected to a plastic deformation. Indeed, the basic principle of the invention is solely the parallelism of both signals in order to keep the difference between both signals constant and thus easily to detect deviations, but the congruence of both signals—as a special form of the parallelism—represents the preferred embodiment, in particular because the difference of both signals S1, S2 is thus null and easy to process, and the voltage values of both measuring bridges 13, 14 are usually null if no pressure is applied.

A plastic deformation of the membrane can thus be detected by determining a difference between both voltage signals S1, S2 alone, without the need for checking the value for plausibility, as in the conventional redundancy systems. How this is carried out is explained in particular in connection with the description of FIG. 6.

FIG. 4 shows a top view of a pressure measuring cell according to the present invention. The four areas 1a, 1b, 1c, 1d are identified with dashed circles for clarification purposes only. These circles are not visible in nature. All eight measuring elements 3, 4 can be seen, the four central measuring elements being located in the inner area 1a and in the second innermost area 1b, and both measuring elements 4a and 4b in the outermost area 1d and respectively second outermost area 1c. The four measuring elements 4a, 4b and the measuring elements 3 located in the second innermost area 1b are arranged at least on the first mid-line ML1 which is shown with a dashed line. The likewise dashed second mid-line ML2 is likewise perpendicular thereto. In the present exemplary embodiment, both mid-lines ML1, ML2 are also the axes of symmetry of the measuring cell 1. What is fundamental to the invention is that the measuring elements 3, 4 are located on one of both mid-lines ML1 or ML2.

The already mentioned possibility of merely dividing the membrane into three concentric areas is not shown further. In this case, the second outermost [area] 1c and the second innermost area 1c of the four-area variant are unified, so that the respective resistances are arranged, for example, placed next to one another in the same area. This takes advantage of the fact that a plastic deformation expands from the inside to the outside, and the resistances in the innermost area 1a thus always have a lead over the resistances in the outer areas 1b, 1c, 1d.

It is basically possible to use strain gauges or a resistance paste or piezo elements for the measuring elements 3, 4. Strain gauges and piezo elements have long been known and do not need to be further explained in this document. Piezo elements operate on the piezo electric principle and the resistance paste on the basis of a piezo resistive effect. The resistance paste has a binding agent with a conductive powder whose concentration is a measure of the specific resistance. Depending on the application, the measuring elements to be used are selected on the basis of the different properties of these alternatives, for example regarding the overload and burst strength resistance, nominal pressure range, accuracy, size, weight as well as signal swing and not least also with regard to the costs to be expected.

Both central measuring elements 3 in the inner area 1a are arranged such that, due to the very small distance to the center of the measuring cell 1, they are subjected to elongation when pressure is applied because the membrane 2 yields to the upward pressure by deformation. As a consequence of the elongation, the resistance value of these measuring elements 3 in the innermost area 1a increases. The other two measuring elements 3 of the resistance bridge in the second innermost area 1b are arranged such that they are not compressed when pressure is applied, with the result that the resistance values would decrease. By changing the resistance in the opposite direction it is possible to generate a clear useful signal in the form of an electrical differential voltage by means of a resistance bridge, for example a Wheatstone bridge, which is further processed in an evaluation unit, which is not shown here, as a measure of the actual pressure. This embodiment is preferably used when the membrane 2 is thinner in the inner areas 1a, 1b. As a result of this, the membrane 2 is especially deformed when pressure is applied to this position.

An especially overpressure-sensitive signal can be generated from the resistances 4, 4a, 4b of both outer areas 1c, 1d, which are likewise interconnected as a measuring bridge, said signal not being as accurate as that of the measuring bridge from the resistances 3, but accurate enough to detect an offset voltage by comparing both measuring bridge signals. This is specified in more detail below in connection with the description of FIG. 6.

As another exemplary embodiment, which is not shown here, the measuring elements 3 forming the first electromechanical transducer can also be arranged in the innermost area 1a and in the second innermost area 1c. Accordingly, the other measuring elements 4a, 4b are located in the second innermost area 1b and in the outermost area 1d. This embodiment is preferably used when the membrane 2 is not thinner in both inner areas 1a 1b, but has the same thickness as in the area 1c. In this case, the area 1a would likewise be subjected to elongation, but the compression would now occur in the area 1c. In contrast, the area 1b is essentially subjected to an extension in the longitudinal direction, i.e. no deflection, because the point of inflection between the convex and concave deformation of the membrane 2 is in this area. The extension of a measuring element likewise means an increase in its resistance. The outermost area 1d is in this case subjected to a slight compression so that a change in resistance in the likewise opposite direction of the measuring elements 4 in both areas 1b, 1d is realized. A third possibility, which is likewise not shown here, is basically to distribute the measuring elements in the innermost area 1a and in the outermost area 1d, and arrange the measuring elements 4 in the areas 1b, 1c. However, the measuring signal difference will then be essentially more unclear so that the embodiment will have fewer diagnostic capabilities.

The operating mechanism of the pressure measuring cell 1 according to the present invention becomes clearer by means of the lateral sectional view from FIG. 5. The progression of the profile of the membrane 2 or of the pressure measuring cell is clearly visible. It can be divided essentially into four areas 1a, 1b, 1c, 1d, the areas 1a, 1b located in the center—also designated as useful area—having the lesser thickness and the resistances 3 arranged there forming the “actual” measuring bridge. When pressure is applied, this part of the membrane 2 is lifted upward so that the two measuring elements 3 arranged closer to the center of the measuring cell are subjected to elongation and the two measuring elements 3 located in the area 1b are subjected to compression. A measuring signal corresponding to the applied pressure can thus be generated by means of a resistance bridge to which the four measuring elements have been connected.

There is a bend area concentrically to the area 1a as a transition between the rigid, only insignificantly deformable area 1d and the useful area. In the outer area 1d of the membrane 2 or of the measuring cell 1 the measuring cell is so thick that an applied pressure only has a slight influence on the change in the surface of the membrane. The resistance element 4a located in this area 1d is thus only slightly dependent on the pressure with a therefore only slight change in resistance when pressure is applied. If it now was the case that, for example, the useful area 1a was plastically deformed by an overpressure peak or also during static overpressure, the measuring elements 3 would generate a continuous signal or a measuring signal increased by an offset voltage. This measuring signal will now no longer correspond to the actually applied pressure. Depending on the magnitude of the overpressure peak, the plastic deformation will only be restricted to the useful area or even extend to both outer areas 1c, 1d. In any case, the degree of the plastic deformation between the inner areas 1a, 1b and the outer areas 1c, 1d is different, and in particular also differs with respect to the behavior in case of an elastic deformation.

FIG. 6 schematically shows a preferred exemplary embodiment of a pressure measuring device according to the present invention in the form of a block diagram with three connections 10, 11, 12. The illustrated pressure measuring device includes a resistance bridge 13 as a sensing element with the resistance elements 3, which are not described in detail in this document, a second resistance bridge 14 arranged parallel to it with the resistance elements 4a and 4b, which are not described in detail in this document. Two resistances are shown to be constant in the measuring bridge 14, which merely is an exemplary embodiment. What is meant in this case are the measuring elements 4a located in the outermost border 1d which vary constantly or only slightly because the deformation of this area 1d is not very great.

Amplifying units 15 and 16 are respectively connected downstream of both resistance bridges 13, 14 which transmit their output signals to a comparator 17, preferentially a window comparator, connected downstream. The comparator 17 transmits its output signal to a current regulator 19 which also receives the measuring signal of the resistance bridge 13 from the amplifying unit 15. The comparator 17 is only a preferred embodiment in this case. The dashed box should represent a general comparison unit because the illustrated comparison unit—and thus the amplifying units 15, 16 as well as the comparator 17—can also be replaced by a microprocessor. The analog signals from both amplifiers 15, 16 can also be sent directly to a control unit, e.g. a programmable logic controller—PLC. The invention is thus not limited to the exemplary embodiment shown in FIG. 6, but can in particular also be configured in a different manner, in particular concerning the comparison function.

As FIG. 6 shows, regulating and limiting series regulators 18 are provided on the input side in the illustrated preferred exemplary embodiment of a pressure measuring device according to the present invention, [for] the supply voltage of the resistance bridges 13, 14, of the amplifying units 15, 16 and of the comparator 17. If the supply voltage is conveyed already regulated, the voltage regulator 18 can also be dispensed with in the 3-wire circuit shown here.

The current regulator 19 normally provides a current of 4.20 mA. If the current regulator 19 is notified of an error by the comparator 17, it outputs a current via the connection 11 which optionally corresponds to between 0 and 3.5 mA or greater than 20.5 mA. This is then detected as an error by an evaluation unit, which is not shown in detail in this document, and corresponding measures are started. Depending on the safety classification of the operated installation, these measures can be, for example, the output of a corresponding visual and/or acoustic warning message, or also switching the entire installation to the safe, i.e. unpowered, state. Further measures are conceivable, so that the invention is not only limited to those mentioned in this document.

Of course, the pressure measuring device according to the present invention can be configured as a 2-wire circuit. In this case, the connection 11 is omitted; otherwise the configuration is basically identical. What is indispensable in this case is the voltage regulator 18. Furthermore, the current regulator 19 should be configured in a different manner because a reduction of the current to 0 mA is not admissible. Preferentially, the current regulator 19 then transmits a current signal of ≦3.5 mA or ≧20.5 mA in case of an error. Currents in these ranges, i.e. outside the admissible range of 4.20 mA, are not interpreted as errors by the evaluation unit connected downstream, which is not shown in this document.

As an alternative to the embodiment shown in the FIGS. 4 to 6 with respectively two resistance bridges 4a, 4b in the outer areas 1b, 1c, the number of resistance elements can also be reduced to one each. In this case, the one resistance element 4a and the one resistance element 4b would form a voltage divider. In contrast to the described embodiment with respectively two resistance elements, the signal swing of the reference signal is, however, smaller by half. Errors with only a slight signal difference would then be more difficult to detect.

The advantages of the pressure measuring cell 1 according to the present invention or of the measuring device can be summed up such that the detection of a permanent, irreversible, i.e. plastic deformation, of the surface of the membrane is possible in a simple manner and without having to provide two separate measuring devices or at least two separate measuring cells.

1. A pressure measuring cell for the detection of the pressure prevailing in an adjoining medium, comprising:
an elastic membrane on which a first electromechanical transducer with a plurality of first measuring elements is arranged, which supplies a first pressure-dependent output signal; and
a second electromechanical transducer with a plurality of second measuring elements which supplies a second pressure-dependent output signal, wherein in a case of an elastically reversible deformation of the membrane, the two transducers are arranged such that the output signals have a first pressure characteristic, and after an irreversible deformation of the membrane due to an increased pressure load, the same have a significantly different pressure characteristic, and that the plurality of first and second measuring element of at least one transducer are arranged on a first mid-line of the membrane.

2. The pressure measuring cell according to claim 1, wherein the measuring elements are arranged on a first mid-line or on a second mid-line which is perpendicular to the first mid-line (ML1).

3. A pressure measuring cell according to claim 1, wherein the surface of the side of the membrane facing away from the medium is advantageously divided into at least three concentric areas in which the membrane has a different deflection behavior when pressure is applied, and each area has at least one measuring element.

4. The pressure measuring cell according to claim 3, wherein that the electromechanical transducer is formed by measuring elements from respectively two areas of the surface of the membrane.

5. A pressure measuring cell according to claim 3, wherein the measuring element of the innermost area and the measuring element of the outermost area are each a component of different electromechanical transducers.

6. A pressure measuring cell according to claim 1, wherein all measuring elements are at least identical with respect to the material.

7. A pressure measuring cell according to claim 2, wherein the membrane is thinner in at least one of the inner areas, preferentially in the innermost area and second innermost area.

8. An evaluation circuit for a pressure measuring cell according to claim 1, comprising a first sensing element formed of first measuring elements, having an amplifying unit connected downstream of the first sensing element, a comparison unit connected downstream of the amplifying unit, and having a controller connected downstream of the comparison unit, with a sensing element formed by second measuring elements, with a second amplifying unit connected downstream of the second sensing element which is connected downstream of the comparison unit, both sensing elements being differently influenced by the pressure applied to the measuring device.

9. The evaluation circuit according to claim 8 wherein the first and the second measuring elements are arranged on a common membrane of a pressure measuring cell.

10. An electronic pressure measuring device, consisting of a process connection, a housing placed thereon, and of a measuring cell to detect the pressure prevailing in the medium, the measuring cell being configured according to claim 1.

11. The electronic pressure measuring cell according to claim 10, wherein an evaluation circuit is included according to claim 8.

12. A method for measuring the pressure with diagnostic capability, characterized by the following process steps:
simultaneous pressure measurement in a first sensing element and in a second sensing element in the form of measuring signals essentially depending on the pressure, both sensing elements being components of the pressure measuring cell according to claim 1;
amplification of the measuring signals in internal amplifying units dedicated to the respective sensing elements, both characteristics being essentially made to coincide by using respectively different amplifying factors.
determination of the difference or of the ratio of both signals;
comparison of the difference or ratio with a predetermined upper and/or lower threshold value;
output of an error signal if the difference or ratio exceeds or falls short of the predetermined threshold values.

13. The method according to claim 12, wherein after receiving an error signal in the controller an output signal is generated which is outside a defined admissible range, preferentially in the form of a current of ≦3.5 mA or ≧20.5 mA.

14. The method according to claim 13, wherein the output signal is sent to a control unit connected downstream of the controller which starts predetermined safety measures on receipt of this output signal, in particular the output of optical and/or acoustical warning signals or switching the installation to be controlled by the control unit to an unpowered state.
